(19) United States
(12) Patent Application Publication
(10) Pub. No.: US 2024/0041036 A1
(43) Pub. Date: Feb. 8, 2024

(54) BIO PESTICIDAL COMPOSITION CONTAINS NOVEL NONANOATE ESTERS OF SUGARS AND SUGAR ALCOHOLS TO CONTROL LEPIDOPTERA, HEMIPTERA AND THYSANOPTERA INSECTS

(71) Applicant: FERTIS INDIA PVT. LTD., Hyderabad (IN)

(72) Inventors: Rahul Raju KANUMURU, Hyderabad (IN); Shaji George KOCHUMALAYIL, Hyderabad (IN); Anindya SIL, Hyderabad (IN); Prasannakumar Lakshmi GARUDADRI, Hyderabad (IN); Ravikumar SURANENI, Hyderabad (IN); Muthu VADUGANATHAN, Hyderabad (IN); Bhadramurthy VEMULAPATI, Hyderabad (IN)

(21) Appl. No.: 18/256,295

(22) PCT Filed: Dec. 7, 2021
(86) PCT No.: PCT/IN2021/051142

§ 371 Date: Jun. 7, 2023

(30) Foreign Application Priority Data
Dec. 7, 2020 (IN) 202041053237

(51) Int. Cl. A01N 37/12; A01P 7/04

(52) U.S. Cl. CPC A01N 37/12; A01P 7/04

(57) ABSTRACT

The present invention discloses bio-pesticidal composition comprising novel nonanoate esters of sugar or sugar alcohol possessing pesticidal (insecticidal, arachnicidal, molluscicides, microbicidal etc) and herbicidal properties and their potential use in controlling Lepidoptera, Hemiptera and Thysanoptera insects. The present invention further discloses preparation of novel nonanoate esters of sugar or sugar alcohol and their formulations.

### TECHNICAL FIELD OF THE INVENTION

The present invention relates to bio-pesticidal compositions comprising novel nonanoate esters of sugars and sugar alcohols possessing pesticidal (insecticidal, arachnicidal, molluscicides, microbicidal etc) and herbicidal properties and their potential use in controlling, Lepidoptera, Hemiptera and Thysanoptera insects. The present invention further relates to the preparation of novel nonanoate esters of sugars and sugar alcohols and their formulations.

### BACKGROUND OF THE INVENTION

The potent insecticidal activities of naturally occurring sucrose esters against the persistent and damaging whiteflies have shown that sugar esters are a new class of “natural” insecticides that should be exploited for commercial use. This was further demonstrated in articles titled ‘Polyester Insecticides’ and ‘Characterization and insecticidal activity of sucrose octanoate that mixing of sorbitol esters with sucrose esters enhances the insecticidal properties’ of such formulations. It is believed that these reported esters i.e. sucrose laurate or sucrose octanoate act as surfactants to de-wax the insect's protective coating. The insect then either dehydrates or is readily attacked by microbe results in their death. The antimicrobial properties of the sugar ester are affected by the sugar head group, length of the fatty acid and degree of substitution. In addition to this, the carbohydrate moiety might also play a significant role in the antimicrobial activity of fatty acid ester derivatives.

Another article titled ‘Structure-Function Relationships Affecting the Insecticidal and Miticidal Activity of Sugar Ester's published by Gary et al in Journal of Economic Entomology, 2003, 96 (3), discloses synthetic sugar esters such as xylitol or sorbitol hexanoate, octanoate, decanoate and dodecanoate esters as synthetic pesticides.

Whilst, most of the research works were focused on the preparation of sugar esters based on Sucrose, Sorbitol and Xylitol using fatty acids of natural origin with even numbers of carbon atoms, esters of acids with odd number of carbon atoms such as nonanoic acid with sugars and sugar alcohols received scant attention (Article titled ‘Synthesis and Characterization of Insecticidal Sucrose Esters’). In addition to the above, there is hardly any report on the development of fatty acid esters of rare sugars such as psicose and sugar alcohols such as erythritol and their nonanoates esters as potential pest and herb controlling agents.

Therefore, there remains a need in the art to provide effective pesticides with reduced toxicity to aquatic life, animals and plants by exploiting hither to unreported sugars/sugar alcohols. The present invention therefore exploited various sugar nonanoates esters which have not been reported in the prior art as having potential pesticidal (insecticidal, arachnicidal, molluscicides, microbicidal etc.) and herbicidal properties.

### OBJECT OF THE INVENTION

In accordance with the above, it is an object of the present invention to provide nonanoate esters of sugar(s) and sugar alcohol(s) for pest management.

It is another object of the present invention to provide a process for the preparation of nonanoate esters of sugar and sugar alcohols.

It is another object of the present invention to provide stable bio-pesticide compositions comprising nonanoate esters of sugar and sugar alcohols and its process for the preparation thereof.

It is yet another object of the present invention to provide a process for the preparation of composition/formulations of various nonanoate esters of sugars and sugar alcohols.

It is another object of the present invention to provide a process for the preparation of esters of sugar(s) and sugar alcohol(s) with odd number of carbon atoms.

It is a further object of the present invention to provide a bio-pesticide composition comprising sugar or sugar alcohol esters specifically nonanoate esters of sugar and sugar alcohol optionally with insecticidal soap and other excipients.

It is yet another objective of the present invention to provide an environmentally acceptable noni-Loxic seed treatment agent which can enhance the quality of seed vigour, germination and protection of seedling from various soil pathogens and insects from germination to seedling stage (0 to 14 days).

### SUMMARY OF THE INVENTION

In accordance with the above objects, the present invention provides nonanoate esters of sugar(s) and sugar alcohols useful in pest management.

In another aspect, the present invention provides bio-pesticide composition comprising nonanoate esters of sugar(s) or sugar alcohol(s) derived from C3 to C8 carbon atoms along with agriculturally acceptable ingredients.

In an aspect, the nonanoate esters of sugar(s) or sugar alcohols may be selected from the group consisting of Erythritol Nonanoate(s), Xylitol Nonanoate(s), Sorbitol Nonanoate(s), Mannitol Nonanoate(s), Sucrose Nonanoate(s), Fructose Nonanoate(s), Glucose Nonanoate(s), Psicose Nonanoate(s), Xylose Nonanoate(s), Lactose Nonanoate(s), Galactose Nonanoate(s) and Mannose Nonanoate(s).

In an aspect, the sugar and sugar alcohol may be selected from the group consisting of sucrose, lactose, glucose, galactose, maltose, mannitol, fructose, cellobiose, globabiose, psicose, sorbitol, xylitol, erythritol etc. either in their chiral form or racemic form and any polyhydroxy compounds which are of synthetic or natural in origin.

In another aspect, the degree of acylation in the sugar or sugar alcohol having mono, di, tri, terta or higher order is based on the number of available hydroxyl groups in the sugar and in the sugar alcohol with respect to the ratio of nonanoic acid available in the reaction mixture.

In an aspect, the present invention provides a process for preparing environmentally friendly nonanoate esters of sugar/sugar alcohol comprising combination of sugar/sugar alcohol: nonanoic acid in a variable molar ratio of 1:0.9 to 1:7.

In one of the preferred embodiments, the sugar or sugar alcohol is Erythritol.

Accordingly, in another aspect, the invention provides hitherto unreported novel nonanoate esters of erythritol. The novel nonanoate esters of erythritol includes mono, di, tri and tetra esters. These esters are further isolated and subjected to characterization.

In another aspect, the present invention provides an environmentally friendly biopesticide composition comprising nonanoate esters of sugar/sugar alcohol for inhibiting the growth of various insects, arachnids such as aphids, mealy bugs, spider mites, thrips, white flies, lesser grain borer (Rhyzoperta dominica), fall army worm (Spodoptera frugiperda), cotton pink bollworm (Pectinophora gossypiella), stem borer, fungi such as Pyricularia oryzae, Fusarium oxysporum, Alternaria solani, Colletotrichum gloeosporioides etc.

In yet another aspect the present invention provides an environmentally friendly composition comprising nonanoate esters of sugar and agriculturally acceptable excipients which will have better phytotoxic tolerance.

In yet another aspect the present invention provides an environmentally acceptable non-toxic seed treatment agent which can enhance the quality of seed vigour, germination and protection of seedling from various soil pathogens and insects from germination to seedling stage (0 to 14 days).

### DESCRIPTION OF DRAWINGS

FIG. 1 shows IR spectroscopic data of Erythritol nonanoate

FIGS. 2 and 3 shows the cumulative overlaid IR data of all sugar nonanoates

FIG. 4 shows GC chromatogram of Erythritol nonanoates prepared by example 1

FIG. 5 depicts GC chromatogram of Erythritol nonanoates prepared by example 4

FIG. 6 depicts GC chromatogram of xylitol and sorbitol nanonoates

FIG. 7 depicts GC chromatogram of mannitol and sucrose nanonoates

FIG. 8 depicts GC chromatogram of fructose and glucose nanonoates

FIG. 9 depicts GC chromatogram of psicose and xylose nanonoates

FIG. 10 depicts GC chromatogram of lactose and galactose nonanoates

FIG. 11 depicts GC chromatogram of mannose nanonoates

FIG. 12 shows 1HNMR of Monoester of Erythritol nonanoate

FIG. 13 shows 1HNMR of Diester of Erythritol nonanoate

FIG. 14 shows 1HNMR of Tetra ester of Erythritol nonanoate

FIG. 15 showing partial acylation of sugar and sugar alcohols

FIG. 16 shows the result of a field experiment conducted with EN2 formulation on cotton sucking insects' viz. Thrips (Scirtothrips dorsails), Jassids (Amrascabi guttula) and whitefly (Bemisia tabaci).

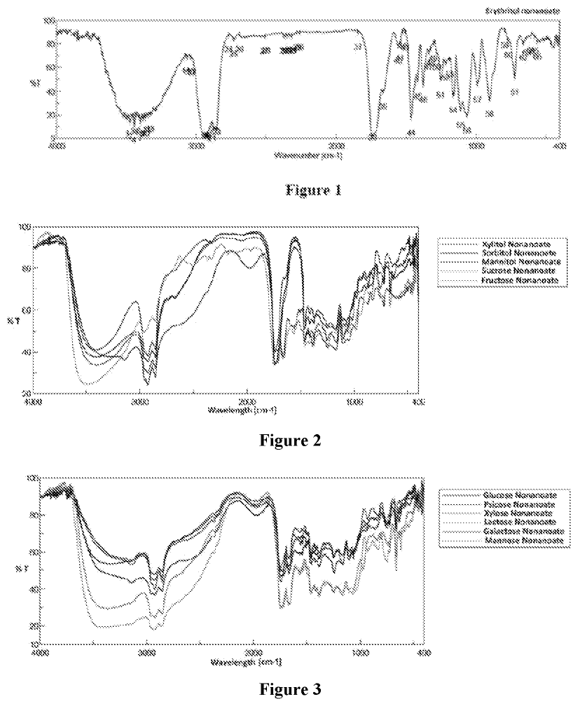

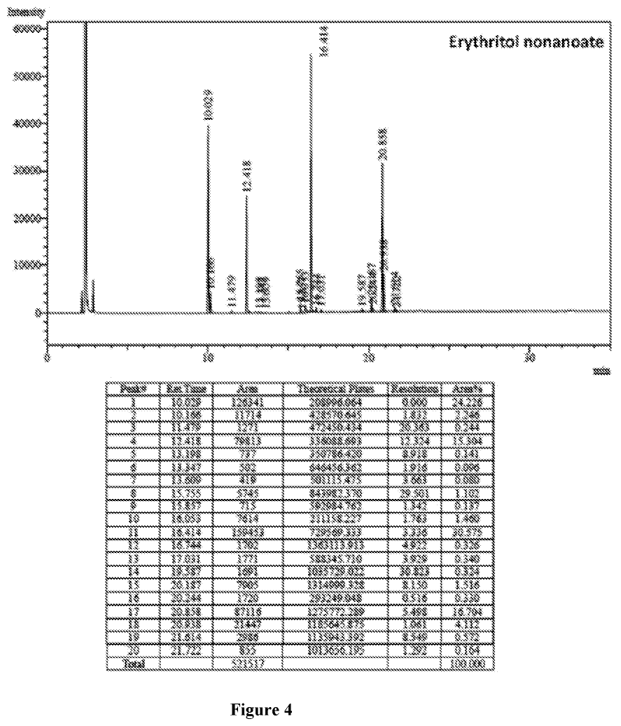

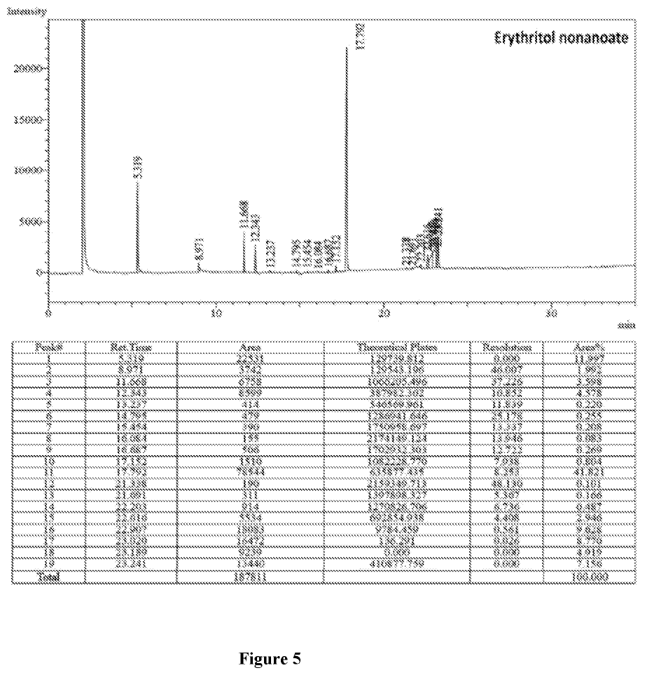

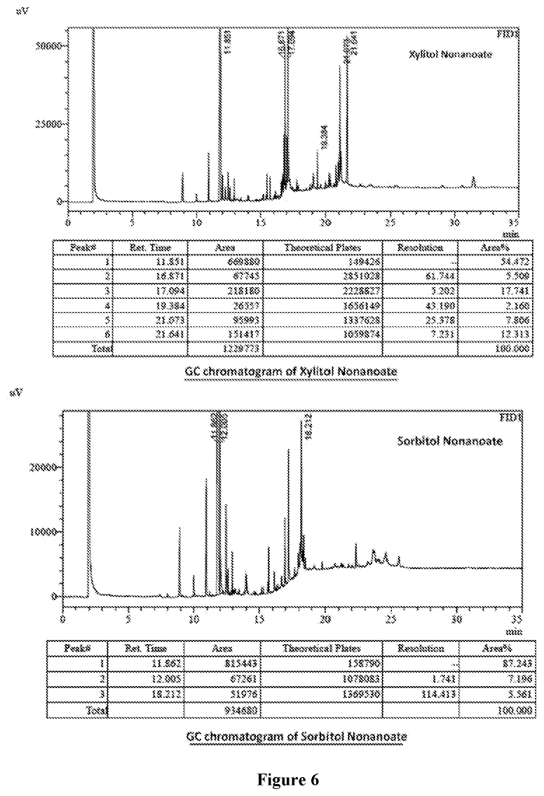

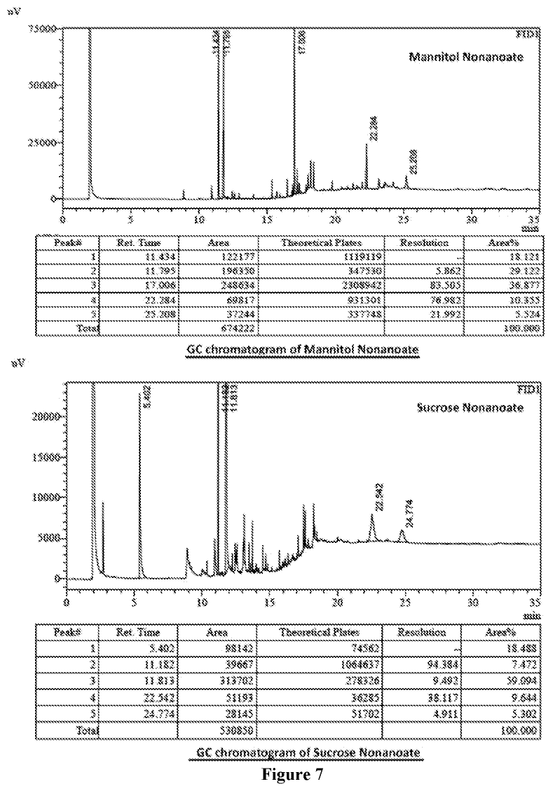

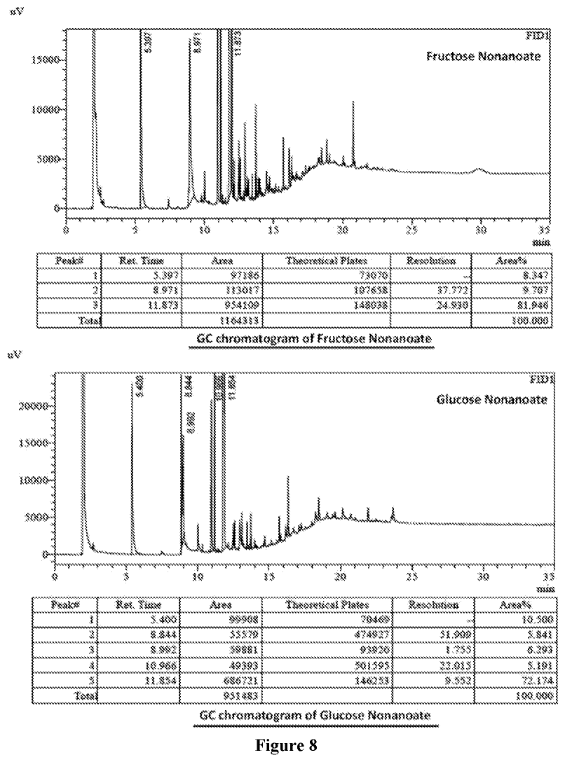

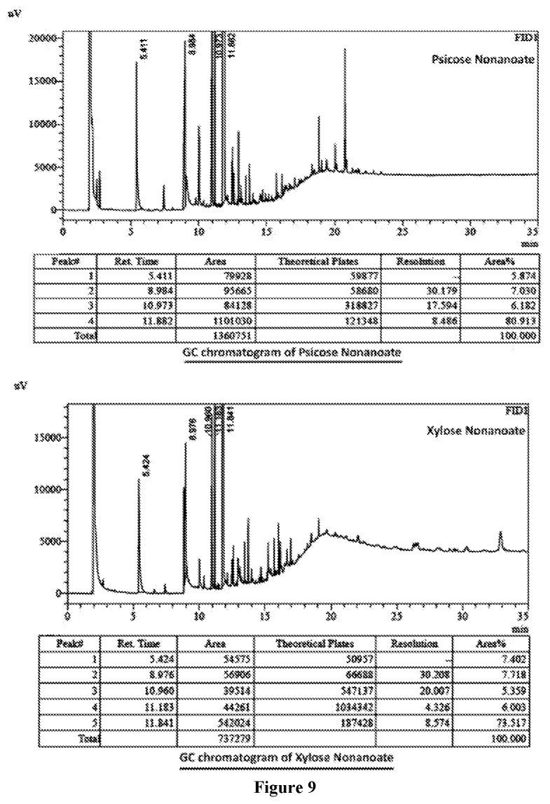

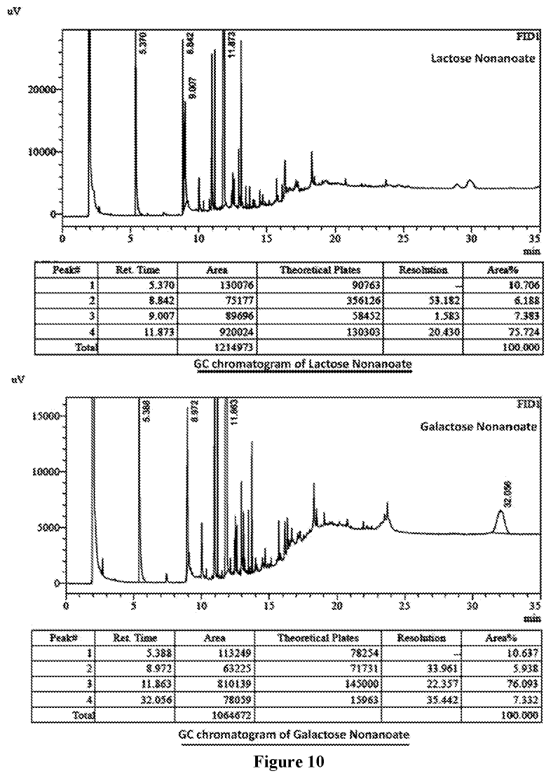

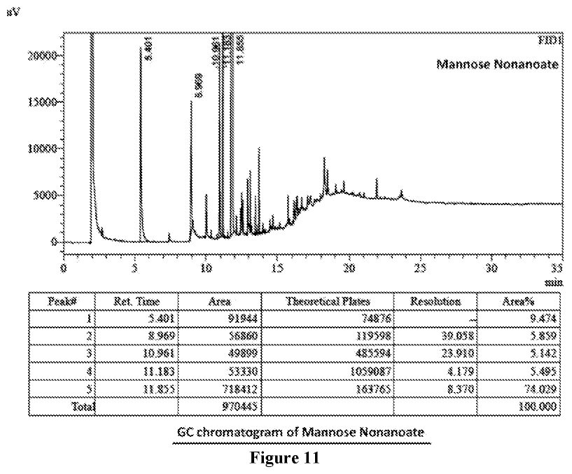

### DETAILED DESCRIPTION OF THE INVENTION

The invention now will be described in detail in connection with certain preferred and optional embodiments, so that various aspects thereof may be more fully understood and appreciated.

The present invention discloses novel nonanoate esters of sugar or sugar alcohol useful in pest management, their preparations, compositions containing the same and application in controlling pests and weeds.

In an embodiment, the sugars and sugar alcohols are selected from the group comprising of sucrose, lactose, glucose, galactose, maltose, fructose, cellobiose, globabiose, psicose, sorbitol, mannitol, xylitol, erythritol etc. either in their chiral pure form or racemic form and any polyhydroxy compounds which are of synthetic or natural in origin.

In an embodiment, the nonanoates esters of sugar or sugar alcohol may be selected from the group consisting of Erythritol Nonanoates, Xylitol Nonanoates, Sorbitol Nonanoates, Mannitol Nonanoates, Sucrose Nonanoates, Fructose Nonanoates, Glucose Nonanoates, Psicose Nonanoates, Xylose Nonanoates, Lactose Nonanoates, Galactose Nonanoates and Mannose Nonanoates.

In one of the preferred embodiments, the sugar or sugar alcohol is Erythritol.

In an embodiment, the invention encompasses hither to unreported novel nonanoate esters of Erythritol. The novel nonanoate esters of Erythritol includes mono, di, tri and tetra esters. These esters are further isolated and subjected to characterization.

Accordingly, the invention provides mono ester of erythritol nonanoate of the following formula.

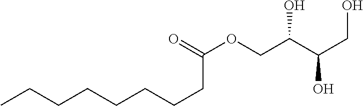 [SMILES: CCCCCCCCC(=O)OC[C@H](O)[C@H](O)CO]

In another embodiment, the invention provides diester of erythritol nonanoate of the following formula.

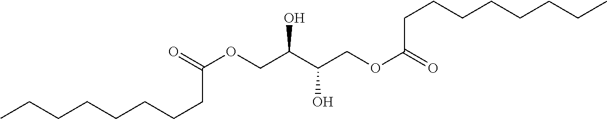 [SMILES: CCCCCCCCC(=O)OC[C@@H](O)[C@@H](O)COC(=O)CCCCCCCC]

In yet another embodiment, the invention provides tetraester of erythritol nonanoate of the following formula.

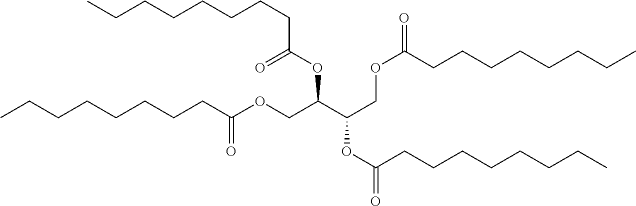 [SMILES: CCCCCCCCC(=O)OC[C@H](OC(=O)CCCCCCCC)[C@@H](COC(=O)CCCCCCCC)OC(=O)CCCCCCCC]

In another embodiment, the invention provides a process for the preparation of nonanoate esters of sugars and sugar alcohols which comprises the steps of,

a) reacting sugar/sugar alcohol with nonanoic acid or its acid chloride in a ratio of 1:0.9 to 1:7 in presence of a suitable solvent and a catalyst selected from the group consisting of acid catalyst, base catalyst, metal salt, Mitsunobu coupling, carbodiimide coupling, carbonyl diimidazole (CDI) coupling, Lipase and Lewis; and
b) Isolating the nonanoate esters of sugar or sugar alcohol.

Accordingly, the said esters can be prepared using acid catalyzed trans-esterification employing the use of an acid catalyst such as phosphoric acid, sulfuric acid, p-toluene sulphonic acid, pyridinium sulphonate, or base catalyzed reactions employing the use of metal carbonate selected from the group consisting of sodium carbonate, potassium carbonate or metal alkoxides selected from the group consisting of sodium or potassium methoxide, ethoxide, potassium tert-butoxide or using metal salts such as zinc chloride, iron chloride, or by Mitsunobu coupling, carbodiimide coupling, carbonyl diimidazole (CDI) coupling, Lipase, and Lewis acids selected from the group of salts of zinc, copper, tin, iron, scandium and gallium.

The suitable solvents for the reaction may be selected from the group consisting of polar aprotic solvents such as DMF, DMSO, acetonitrile etc.

In a preferred embodiment, the present invention discloses a process for preparing nonanoate esters of sugars and sugar alcohols comprising;
(i) Adding sugar/sugar alcohol to nonanoic acid in a variable ratio of 1:0.9 to 1:7 and heating the resultant mixture at a temperature ranging from 110° C. to 180° C.,
(ii) Adding 10-30% moles of Phosphoric acid (with respect to sugar/sugar alcohol) into the mixture of step (i), followed by heating for 8 to 48 h,
(iii) Cooling the mixture of step (ii) to 60-70° C., followed by diluting with ethyl acetate,
(iv) Treating the mixture of step (iii) with Ca(OH)₂ for 10-30 min at this temperature and
(v) Filtering the hot solution through celite bed followed by concentrating the filtrate under vacuum to obtain nonanoate esters of sugars or sugar alcohol.

The nonanoate esters of sugars or sugar alcohol thus obtained after drying under vacuum was further evaluated for its insecticidal properties.

In a specific embodiment, the addition of 1.0 equivalents of sugar/sugar alcohols to 0.9 equivalent of nonanoic acid is sufficient to achieve differently substituted nonanoate esters of sugar or sugar alcohol in very good yield.

In an embodiment, the sugars and sugar alcohols are selected from the group comprising of sucrose, lactose, glucose, galactose, maltose, fructose, cellobiose, globabiose, psicose, sorbitol, mannitol, xylitol, erythritol etc. (Without limitations to the listed sugar and sugar alcohols) either in their chiral form or racemic form and any polyhydroxy compounds which are of synthetic or natural in origin.

In another embodiment, the nonanoic acid can be used either alone or in combinations with other fatty acids. The degree of acylation having mono, di, tri, tertra or higher order based on the number of available hydroxyl groups in the sugar, sugar alcohol moieties with respect to the ratio of acids available.

In an alternative embodiment, nonanoate esters of sugar/sugar alcohol were made using acid chloride method where in 1.0 equivalent of nonanoic acid chloride was added to a hot and stirred solution of sugar/sugar alcohol (1.1 equivalent) in dry DMF and pyridine. The mixture was stirred at 80° C. until all the acid chloride was consumed. It was cooled to rt and diluted with ethyl acetate (5 v), washed with water, followed by dilute HCl, then with cold bicarbonate solution and finally with brine. Organic phase separated, dried (anhydrous sodium sulphate), filtered and evaporated under vacuum. The residue thus obtained was used as such for further studies.

In another embodiment, the said esters can also be prepared using carbonyl diimidazole (CDI) in DMF at 0-5° C. To a solution of nonanoic acid (0.9 equivalent) in DMF was added N,N carbodiimidazole (CDI, 1.2 equivalent) in aliquotes under nitrogen atmosphere. The temperature of the reaction mixture was maintained at 0-5° C. during the addition of CDI. After the complete addition of CDI, the reaction mixture was stirred for 10 min at 0-5° C. under nitrogen atmosphere. Into this was added Erythritol (1.0 equivalent) in aliquots. It was stirred for 24 h, treated with ice cold water and extracted with ethyl acetate. Organic phase separated, washed with saturated brine solution and dried over anhydrous sodium sulfate. Volatiles were removed under reduced pressure to give mixtures of esters as light brown material.

In another embodiment, the composition comprises nonanoate ester with silica, nano silica diatomaceous earth for the control of pest and insects.

In another embodiment, the present invention provides a composition comprising sugar/sugar alcohol esters with seed treatment nutrient agents to offer better germination and protection of the seedlings against various pests at their early stages of growth (0-14 days) which are present in the soil.

In another preferred embodiment, the present invention provides a composition comprising sugar/sugar alcohol esters, specifically a composition comprising nonanoates of sugar/sugar alcohol esters along with other agriculturally acceptable ingredients selected from the following:
a) Oxidation pathway inhibitors such as gallic acid or tannic acid for reducing resistance,
b) Other insecticides/pesticides natural or synthetic,
c) Plant nutrients, stimulants, hormones, PGR etc.,
d) Pheromones,
e) Surfactants, spreaders, stickers, penetrants etc.,
f) Carrier oil,
g) Anti-oxidants such as ethoxyquin, a tocopherol, BHT, etc.,
h) Arginine, Lysine, Glycine, nitrosglutathione, sodium nitrospruside, sodium hydrogen sulphide which may act as adjuvents,
i) Nonionic, Cationic and Anionic surfacts such as Tween (Poly sorbate), or any secondary alcohol ethoxylate, Tergitol (anionic sulfonate), spreading agents such as Silwet (Polyalkyleneoxide modified heptamethyltrisiloxane) and long chain alcohol ranging from C 8 to C 20.

Accordingly, the present invention provides a final composition comprising sugar/sugar alcohol esters in a concentration ranging from 0.1 to 4% by weight of the composition. The other elements including excipients in the present composition ranging from 0.1% to 96% by weight of the composition and water in a concentration ranging from 0 to 90%.

Accordingly, the present composition can be formulated as liquids, soaps, pellets, granules, suspensions, gels, solutions and aerosol sprays.

In another preferred embodiment, the present invention provides composition comprising nonanoate esters of sugar/sugar alcohols formulated as an insecticidal soap along with agriculturally acceptable excipients selected from the group consisting of surfactants, carrier oil, anti-oxidants such as ethoxyquin, a tocopherol, BHT, etc.

The present invention is explained further in detail by illustrating examples below.

Some typical examples illustrating the embodiments of the present invention are provided; however, these are exemplary only and should not be regarded as limiting the scope of the present invention.

### Example 1: General Procedure for the Preparation of Sugar Nonanoates Using Acid Catalysis

### Preparation of Erythritol Nonanoate

Nonanoic acid (4.7 kg, 29.77 moles) was charged into a three necked RB (10 L) fitted with a short distillation head and a mechanical stirrer. Into this was added erythritol (4.0 kg, 32.75 moles) in aliquots. The reaction mixture was heated to 120° C. Into this was added phosphoric acid drop wise (10 mole percent, with respect to Erythritol) under stirring. The temperature of the reaction mixture slowly raised to 150° C. and stirred for 30 h. It was allowed to reach rt, diluted with ethyl acetate (6.0 L) and treated with calcium hydroxide (242 g). It was filtered through celite bed and the filtrate dried (anhydrous sodium sulphate), evaporated under reduced pressure and dried to give an amber colored viscous liquid. Yield: 7.2 kg.

### GC Analysis of Erythritol Nonanoates:

| | | Percentage |
|---|---|---|
| SL. | Compositions | in the |
| No. | and RT | mixture |
| 1 | Erythritol nonanoate | 10.30% |
| | monoestser @ 17.6 | |
| 3 | Erythritol nonanoante | 29.82% |
| | diestser @ 22.70 | |
| | (Positional isomer) | |
| 4 | Erythritol nonanoante | 42.70% |
| | tetra estser @ 12.45 | |
| | Positional isomer) | |

### Example 2: General Procedure for the Preparation of Sugar Nonanoates Using Acid Chloride Method

### Preparation of Xylitol Nonanoate

A solution of nonanoyl chloride (19.4 g, 0.11 mole) in acetonitrile (115 mL) was added to a suspension of xylitol (20.0 g, 0.12 mol) in DMF (100 mL) and pyridine (32.0 mL) at rt. It was stirred for 24 h during which TLC showed the disappearance of the starting materials. It was treated with cold water (400 mL) and extracted with ethyl acetate (2×100 mL). The organic phases combined, combined phase washed with cold dil. HCl (10 mL×3) followed by brine (50 mL×2) and then dried (anhydrous sodium sulphate). It was filtered and the filtrate evaporated to dryness to give an off white viscous liquid. Yield: 30.0 g. The individual esters of Xylitol nonanoates thus obtained are not separated and used as such for the preparation of insecticidal formulation; GC analysis shows the formation of mixed esters as expected.

### GC Analysis Data of Xylitol Nonanoates:

| SL. | Retension | |
|---|---|---|
| No. | time (min) | Composition |
| 1 | 11.85 | 54.0% |
| 2 | 16.87 | 05.5% |
| 3 | 17.09 | 17.7% |
| 4 | 21.07 | 07.8% |
| 5 | 21.64 | 12.3% |

### Example 3: General Procedure for the Preparation of Sugar Nonanoates Using N,N′Carbodiimidazole

### Preparation of Fructose Nonanoates

To a stirred solution of nonanoic acid (20.0 g, 126 mmole) in DMF (120 mL) was added N,N′ carbodiimidazole (CDI) (24.5 g, 150 mmole) in aliquots at 0-5° C. After 10 min, was added fructose (7.6 g, 42 mmole) in small portions. The reaction mixture allowed to reach rt and the mixture stirred for further 24 h, during which TLC showed the disappearance of the starting materials. Reaction was quenched by the addition of ice cold water and the content was extracted with ethyl acetate (100 mL×3). The organic phases combined and combined phase washed with saturated brine and dried (anhydrous sodium sulfate). Volatiles were removed under reduced pressure to yield a light brown syrupy material. The individual esters of sugar nonanoates thus obtained are not isolated and used as such for the insecticidal formulation. GC analysis indicates the formation of mixed esters, as shown below. Yield 22 g.

### GC Analysis of Data Fructose Nonanoates:

| SL. | Retension | |
|---|---|---|
| No. | time (min) | Composition |
| 1 | 5.39 | 8.3% |
| 2 | 8.97 | 9.7% |
| 3 | 11.87 | 81.9% |

### GC Analysis of Data Erythritol Nonanoates:

| SL. | Name of the | |
|---|---|---|
| No. | compound and RT | Composition |
| 1 | Erythritol nonanoate | 41.8% |
| | monoestser @ 17.79 | |
| 3 | Erythritol nonanoante | 08.8% |
| | diestser @ 23.02 | |
| | (Positional isomer) | |
| 4 | Erythritol nonanoante | 04.9% |
| | diestser @ 23.19 | |
| | (Positional isomer) | |
| 5 | Erythritol nonanoate | 04.5% |
| | tetra ester @ 12.3 | |

### GC Analysis of Data Sucrose Nonanoates:

| SL. | Retension | |
|---|---|---|
| No. | time (min) | Composition |
| 1 | 05.4 | 08.3% |
| 2 | 11.18 | 09.7% |
| 3 | 11.81 | 81.9% |
| 4 | 22.54 | 09.6% |
| 5 | 24.77 | 05.3% |

The following nonanoate esters of sugars were prepared using one of the above mentioned methods:—

Erythritol Nonanoates, Xylitol Nonanoates, Sorbitol Nonanoates, Mannitol Nonanoates, Sucrose Nonanoates, Fructose Nonanoates, Glucose Nonanoates, Psicose Nonanoates, Xylose Nonanoates, Lactose Nonanoates, Galactose Nonanoates, Mannose Nonanoates.

### Analytical Data:

The density of sugar esters varies between 0.96 to 01.04 g/mL.

TABLE 1

| Sl. No. | Compound Name | Density |
|---|---|---|
| 1 | Erythritol Nonanoates | 1.01 g/mL @ 30° C. |
| 2 | Xylitol Nonanoates | 0.98 g/mL @ 30° C. |
| 3 | Sorbitol Nonanoates | 0.99 g/mL @ 30° C. |
| 4 | Mannitol Nonanoates | 0.99 g/mL @ 30° C. |
| 5 | Sucrose Nonanoates | 1.04 g/mL @ 30° C. |
| 6 | Fructose Nonanoates | 0.99 g/mL @ 30° C. |
| 7 | Glucose Nonanoates | 0.98 g/mL @ 30° C. |
| 8 | Psicose Nonanoates | 0.96 g/mL @ 30° C. |
| 9 | Xylose Nonanoates | 0.98 g/mL @ 30° C. |
| 10 | Lactose Nonanoates | 0.99 g/mL @ 30° C. |
| 11 | Galactose Nonanoates | 0.99 g/mL @ 30° C. |
| 12 | Mannose Nonanoates | 1.01 g/mL @ 30° C. |

The FTIR further confirmed the formation of esters.

### GC Analysis Data

GC analysis was done for all the crude samples of sugar nonanoates. The column used is ZB5 30m×0.25 mm×0.25 μm, Make Phenomenex. Injector temperature 250° C., Detector temperature 300° C., Column Flow 1 mL/min, Carrier gas Nitrogen, Injection volume is 1 μL.

From G.C analysis data it is evident that polyhydroxy sugar and sugar alcohols undergone esterification with nonanoic acid either partially or fully leading to the formation of mixtures of mono, di, tri and tetra esters in varying proportions. The mixture of esters may be also formed from different regio isomers.

This composite mixture of nonanoate esters in different proportions is very powerful insecticidal agents, whose activity is clearly explained in entomological studies. Moreover, since the composite mixtures are used as such, without subjecting to isolation of individual esters; the composition of these insecticidal agents are cost effective.

### Chromatographic Purification

The crude erythritol nonanoates prepared by example 1 and 4 were subjected to silica gel column chromatography (100-200 mesh, Make SD Fine Chemicals) purification using Ethyl Acetate-Hexane (30 to 70%) as eluent. The fractions were collected, evaporated, dried and characterized using H NMR.

The ¹HNMR data of these esters are given below.

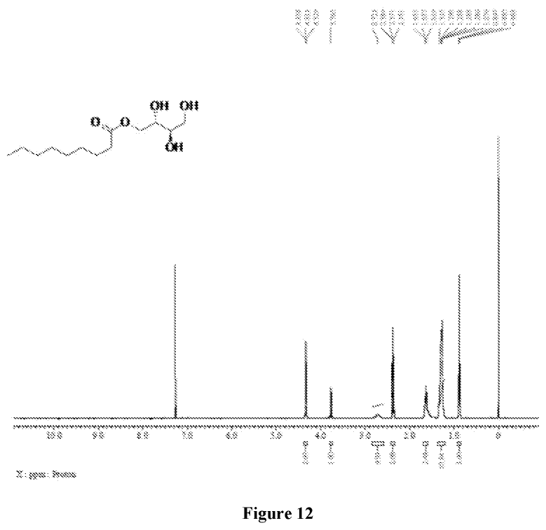

¹HNMR of monoester of Erythritol nonanoate: (500 MHz, CDCl₃) δ 0.88 (3H, t, J 1=6.9 Hz), 1.3 (10H, m), 1.64 (2H, m), 2.37 (2H, t, J 1=7.6 Hz), 2.72 (1H, s), 3.76 (1H, s), 4.33 (2H, t, J 1=1.9 Hz) (FIG. 12)

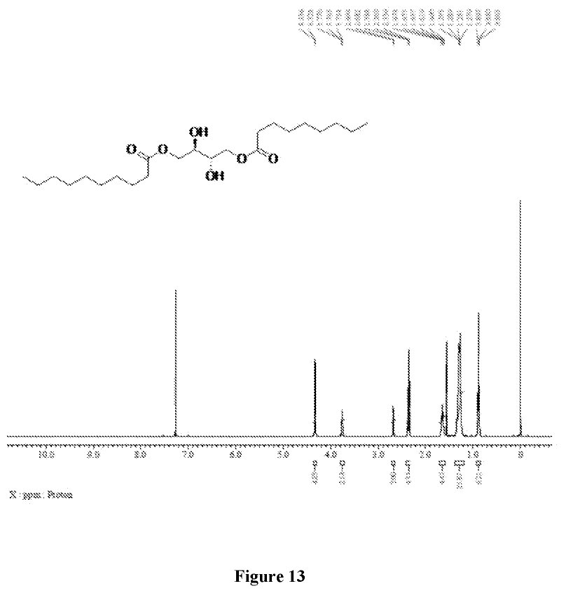

¹HNMR of Diester of Erythritol nonanoate: (500 MHz, CDCl₃) δ 0.88 (6H, t, J 1=6.8 Hz), 1.28 (22H, m), 1.64 (4H, m), 2.37 (4H, t, J 1=7.6 Hz), 2.69 (2H, d, J 1=4.5 Hz), 3.76 (2H, t, J 1=4.4), 4.33 (4H, t, J 1=3.4 Hz) (FIG. 13)

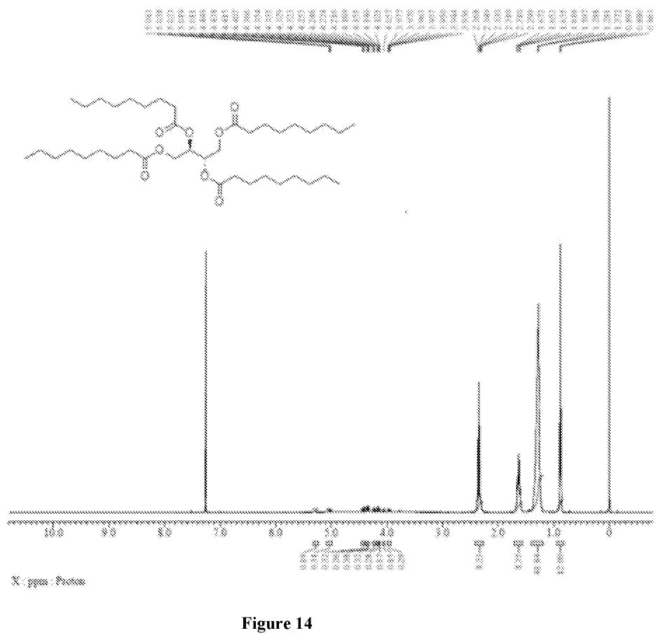

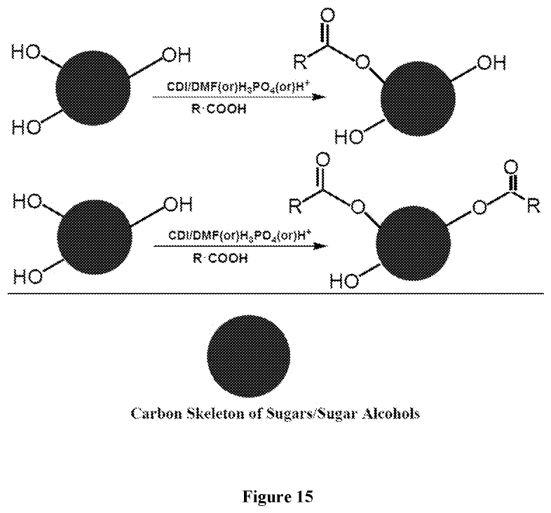

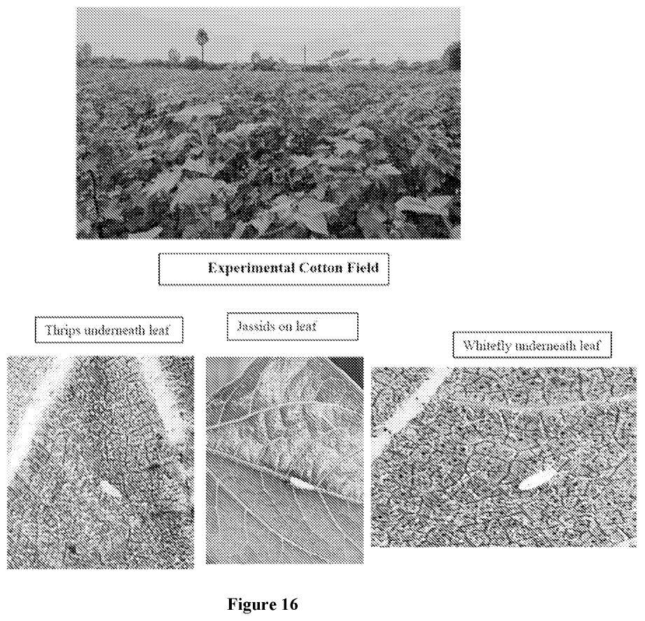

¹HNMR of tetraester of Erythritol nonanoate: (500 MHz, CDCl₃) δ 0.88 (12H, t, J 1=6.9 Hz), 1.28 (42H, m), 1.63 (8H, m), 2.33 (8H, m) (FIG. 14)

Entomological studies were carried out on different pests using various nonanoate esters of sugar/sugar alcohols@ 0.25%; 0.5% and at 1% concentration and the mortality rate is observed after 48 h, as shown in table 2 to 4. The following pests were selected for entomological studies:

1. Fall armyworm (Spodoptera frugiperda)

2. Cotton pink bollworm (Pectinophora gossypiella)

3. Corn leaf aphid (Rhopalosiphum maidis)

4. Hibiscus mealybug (Maconellicoccus hirsutus)

TABLE NO. 2
Mortality rate @ 0.25% concentration after 48 h

| | Fall Army | Cotton pink | | |
|---|---|---|---|---|
| Compound Name | worm | bollworm | Aphids | Mealybug |
| Erythritol Nonanoate | Very Good | Minimal | Very good | Minimal |
| Xylitol Nonanoate | Excellent | Minimal | Good | Minimal |
| Sorbitol Nonanoate | Excellent | Very good | Good | Minimal |
| Mannitol Nonanoate | Excellent | Minimal | Good | Minimal |
| Sucrose Nonanoate | Excellent | Minimal | Minimal | Minimal |
| Fructose Nonanoate | Excellent | Minimal | Minimal | Minimal |
| Glucose Nonanoate | Minimal | Minimal | Minimal | Minimal |
| Psicose Nonanoate | Minimal | Minimal | Minimal | Minimal |
| Xylose Nonanoate | Minimal | Minimal | Minimal | Minimal |
| Lactose Nonanoate | Minimal | Minimal | Minimal | Minimal |
| Galactose Nonanoate | Minimal | Minimal | Minimal | Minimal |
| Mannose Nonanoate | Very Good | Minimal | Minimal | Minimal |
| Delegate (1 ml/L, | Excellent | Excellent | Excellent | Excellent |
| Market control) | | | | |

TABLE NO. 3
Mortality rate @ 0.5% concentration after 48 h

| | Fall Army | Cotton pink | | |
|---|---|---|---|---|
| Compound Name | worm | bollworm | Aphids | Mealybug |
| Erythritol Nonanoate | Very Good | Minimal | Excellent | Minimal |
| Xylitol Nonanoate | Excellent | Minimal | Very Good | Minimal |
| Sorbitol Nonanoate | Excellent | Excellent | Very Good | Minimal |
| Mannitol Nonanoate | Excellent | Very Good | Very Good | Minimal |
| Sucrose Nonanoate | Excellent | Very Good | Minimal | Minimal |
| Fructose Nonanoate | Excellent | Minimal | Minimal | Minimal |
| Glucose Nonanoate | Minimal | Minimal | Minimal | Minimal |
| Psicose Nonanoate | Very Good | Minimal | Very Good | Minimal |
| Xylose Nonanoate | Minimal | Minimal | Minimal | Minimal |
| Lactose Nonanoate | Minimal | Very Good | Minimal | Very Good |
| Galactose Nonanoate | Minimal | Minimal | Minimal | Minimal |
| Mannose Nonanoate | Very Good | Very Good | Minimal | Minimal |
| Delegate (1 ml/L, | Excellent | Excellent | Excellent | Excellent |
| Market Control) | | | | |

TABLE NO. 4
Mortality rate @ 1% concentration after 48 h

| | Fall Army | Cotton pink | | |
|---|---|---|---|---|
| Compound Name | worm | bollworm | Aphids | Mealybug |
| Erythritol Nonanoate | Very Good | Minimal | Excellent | Minimal |
| (EN) | | | | |
| Xylitol Nonanoate | Excellent | Minimal | Very Good | Minimal |
| Sorbitol Nonanoate | Excellent | Excellent | Excellent | Very Good |
| Mannitol Nonanoate | Excellent | Excellent | Excellent | Minimal |
| Sucrose Nonanoate | Excellent | Excellent | Minimal | Minimal |
| Fructose Nonanoate | Excellent | Very Good | Minimal | Very Good |
| Glucose Nonanoate | Minimal | Minimal | Minimal | Very Good |
| Psicose Nonanoate | Very Good | Minimal | Very Good | Minimal |
| Xylose Nonanoate | Minimal | Minimal | Minimal | Minimal |
| Lactose Nonanoate | Minimal | Excellent | Minimal | Excellent |
| Galactose Nonanoate | Excellent | Minimal | Very Good | Minimal |
| Mannose Nonanoate | Excellent | Excellent | Very Good | Minimal |
| Delegate (1 ml/L, | Excellent | Excellent | Excellent | Excellent |
| Market control) | | | | |

Note: Efficacy categories based on mortality rate; Minimal: 0 to 50% mortality: Good: 50 to 70% mortality: Very Good: 70 to 90% mortality: Excellent: 90 to 100% mortality.

While the market control Delegate is 11.7% SC concentration; the claimed formulations are tested with 0.25 to 1% concentration. The active, Spinetoram in the Delegate is a synthetic product, whereas, the claimed compositions are of organic in nature. Also, the claimed compositions are cheapest in the light of cost effective synthesis, easily available raw materials and the lower amount of the active ingredient required to achieve the pesticidal activity and also with no toxic effect to aquatic, mammalian and the plants and hence it is safe to use as well as safe to consume the produce of such treated plants.

The following Erythritol Nonanoate (EN-formulations) were prepared, wherein, EN refers to the Erythritol nonanoate esters prepared as per example 1

TABLE NO. 5

| Sl. No. | Code | Formulation Details |
|---|---|---|
| 1 | EN-1 | EN + Tergitol + Silwet + Water |
| | | (8 g + 200 mg + 200 mg + 2 mL) |
| 2 | EN-2 | EN1 + Arginine (5 mL + 400 mg) |
| 3 | EN-3 | EN1 + Gallic Acid (5 mL + 400 mg) |
| 4 | EN-4 | EN1 + Arginine + Gallic Acid |
| | | (5 mL + 400 mg + 400 mg) |

The above mentioned formulations were tested in laboratory (in vivo study) to determine their insecticidal activity against fall armyworm (Spodoptera frugiperda). Positive control (market control) used is Delegate (Spinetoram 11.7% SC); a broad spectrum insecticide from Dow Agrosciences. Negative control used is sterile water. Surface application method (topical) was used for this study. For each formulation three insect larvae were tested. Each larva was dipped into the solution containing active ingredient to ensure the entire body of larva covered by test solution. The effects of the formulations were observed at 17 h, 24 h and 48 h after the application of the product. The mortality rate was determined by counting the number of live and dead insect larva. No mortality was observed for negative control.

Similar experiment was performed on cotton pink boll worm (Pectinophora gossypiella). The comparative data on two different insects are provided in table 6.

TABLE NO. 6
Percentage Mortality Rate of EN Formulation

| | Mortality Rate @ 48 h | | | |
|---|---|---|---|---|
| | Fall Army Worm | | Pink boll worm | |
| Sample | Concentration | | Concentration | |
| Code | 0.2% | 1% | 0.2% | 1% |
| Delegate | Excellent | Excellent | Excellent | Excellent |
| (Market | | | | |
| Control) | | | | |
| EN 1 | Excellent | Excellent | Minimal | Excellent |
| EN 2 | Excellent | Excellent | Minimal | Minimal |
| EN 3 | Very Good | Excellent | Minimal | Minimal |
| EN 4 | Very Good | Excellent | Minimal | Minimal |

### Phytotoxicity Study

The phytotoxicity study was performed on Tomato/Chili plants (Germination to various stages of crop). The formulations were diluted with water and applied by spraying on leaves. Phytotoxicity was carried out by visual observation of leaves before and again at 72 h after spraying. The results of the same are discussed in table 7.

TABLE NO. 7
Phytotoxicity results of EN Formulation

| | Observation after 72 h of EN | | | |
|---|---|---|---|---|
| | spraying | | | |
| Sample | Concentration | | | |
| Code | 0.2% | 0.5% | 1.0% | 3.0% |
| EN 1 | None | None | None | moderate |
| EN 2 | None | None | None | moderate |
| EN 3 | None | None | None | moderate |
| EN 4 | None | None | None | moderate |

### Phytotoxicity Categories

None—No signs of phytotoxicity
Slight—A few scorching or discoloration of leaves
Moderate—Significant scorching spotting or discoloration of leaves but less than 20% of leaf area
Severe—Severe scorching or curling of leaves with necrosis

From above phytotoxicity data it was reflecting that up to 1% concentration these formulations are very safe to use as broad-spectrum insecticide in the tested Tomato/Chili plants.

A field experiment was conducted with EN2 formulation on cotton sucking insects viz. thrips (Scirtothrips dorsails), aphids (Aphis gossypii), jassids (Amrascabi guttula) and whitefly (Bemisia tabaci), as shown in FIG. 25. Two benchmark insecticides were used as control viz. Thiamethoxam (a broad spectrum insecticide) and Acetamiprid (effective to cotton sucking pest). Three doses of EN 2 formulation (for 1 kg formulation EN 800 g+Arginine 80 g+Silwet20 g+Tergitol 20 g+Water 150 g) was used for this study viz. 1.25 g/L, 2.5 g/L and 5 g/L.

Initially the population of the pests (pre count) was assessed before spraying. The field was found to be above economic threshold level. The number of major sucking pests (2 leaves from top, one from middle and 2 leaves from bottom) in 5 tagged plants/treatment was recorded at 24 h before the spray and after 24 h, 3^{rd}, 6^{th} and 9^{th} day after spray. The data was pooled and average population calculated.

### Effect of EN2 on Thrips Population

EN 2 reduced the thrips population by 15.18% as compared to Thiamethoxam (15.9%) and Acetamiprid (13.7%) after 24 h. On 3^{rd} day of application, EN 2 @ 5 g/L reduced the thrips population by 28.85% as compared to 31.6% by Thiamethoxam. Acetamiprid reduced the thrips population by 19.76%. At 6^{th} and 9^{th} days observation also showed that EN 2 gave almost on par effect as that of Thiamethoxam and Acetamiprid. The results are discussed below in Table 8. Thiamethoxam and Acetamiprid are also synthetic compounds similar to Spinetoram when compared to the current biopesticide compositions, which is of organic in nature. Therefore, the biopesticide compositions are safe to use and also safe to consume the produce of such treated plants. Further, the biopesticide composition of the present invention does not leave any residue either on the plant or on the produce and thus safe. Further, the composition of the present invention is cost-effective when compared to the existing marketed products as the the production of the same is industrially scalable by using readily available raw materials, as demonstrated in the invention. Also, the Nonanoate esters formed in the process of the present invention can be used as such and no need for the separation of individual esters thereby further reduces the cost of the manufacturing process and thus the product.

TABLE NO. 8
Thrips population count after spray

| Sl. | Sample Name & | Pre- | | 3rd | 6th | 9th |
|---|---|---|---|---|---|---|
| No. | Dose | treatment | 24 h | day | day | day |
| 1 | EN 2 @ 1.25 g/L | 29 | 22.9 | 4.53 | 5.53 | 3.56 |
| 2 | EN 2 @ 2.5 g/L | 28 | 26.7 | 4.43 | 5.53 | 3.73 |
| 3 | EN 2 @ 5 g/L | 25 | 26 | 3.6 | 5.66 | 3.4 |
| 4 | Thiamethoxam | 28 | 23.7 | 3.46 | 5.33 | 3.76 |
| | @ 0.5 g/L | | | | | |
| 5 | Acetamiprid | 30 | 22.7 | 4.06 | 5.66 | 3.6 |
| | @ 0.5 g/L | | | | | |
| 6 | Control | 29 | 27 | 5.06 | 6.6 | 6.26 |

### Effect of EN 2 on Jassids Population

EN 2 reduced the Jassids population by 8.9% on 3^{rd} day after the spray against 11.8% by Thiamethoxam. However at 9^{th} day, Thiamethoxan reduced the Jassid population by 40.6% as compared to EN 2 reduced the population by 29.1%. EN 2 spray gave almost similar Jassid population to Acetamiprid application. The results are discussed in Table 9.

TABLE NO. 9
Jassids population count after spray

| Sl. | Sample Name & | Pre- | | 3rd | 6th | 9th |
|---|---|---|---|---|---|---|
| No. | Dose | treatment | 24 hrs | day | day | day |
| 1 | EN 2 @ 1.25 g/L | 13.66 | 11.66 | 3.6 | 2.13 | 3.06 |
| 2 | EN 2 @ 2.5 g/L | 14.66 | 11.33 | 3.93 | 2.33 | 3.33 |
| 3 | EN 2 @ 5 g/L | 13 .. 33 | 9 | 3.4 | 2.53 | 3.4 |
| 4 | Thiamethoxam | 16.33 | 13.66 | 3.26 | 2 | 2.73 |
| | @ 0.5 g/L | | | | | |
| 5 | Acetamiprid | 16.33 | 14 | 3.56 | 2.66 | 3.36 |
| | @ 0.5 g/L | | | | | |
| 6 | Control | 14.33 | 14 | 4.83 | 2.53 | 4.6 |

### Effect of EN 2 on Whitefly Population

EN 2 from Insects spray significantly reduced the Whitefly population, which was almost on par to Thiamethoxan and Acetamiprid, as shown in table 10.

TABLE NO. 10
Whitefly population count after spray

| Sl. | Sample Name & | Pre- | | 3rd | 6th | 9th |
|---|---|---|---|---|---|---|
| No. | Dose | treatment | 24 h | day | day | day |
| 1 | EN 2 @ 1.25 g/L | 11.66 | 11 | 2.06 | 2.6 | 1.86 |
| 2 | EN 2 @ 2.5 g/L | 11.33 | 9.66 | 1.9 | 2.93 | 1.4 |
| 3 | EN 2 @ 5 g/L | 9 | 8.66 | 1.6 | 2.13 | 1.66 |
| 4 | Thiamethoxam | 13.66 | 7 | 1.86 | 2.46 | 1.7 |
| | @ 0.5 g/L | | | | | |
| 5 | Acetamiprid | 14 | 8.66 | 1.66 | 2.4 | 2.13 |
| | @ 0.5 g/L | | | | | |
| 6 | Control | 14 | 12 | 3.7 | 3.26 | 3.66 |

### Method of Seed Treatment:

A mixture of nutrient solution (2.5 mL) and erythritol nonanoate esters (1 mL) were mixed well, applied on maize seeds (1.0 kg), tested for germination and protection in soil for 15 days. The same procedure repeated by increasing the quantity of erythritol nonanoate esters per kg of the seeds and tested again.

Table 11 shows the results of seeds treated with a combination of nutrient and erythritol nonanoates against Fall Army Worm.

TABLE 11
Evaluation of Trail Blaze and Ecolaid freedom on
Maize seed—Kharif 2021 on Fall Army Worm control

| S. | | Dosage/kg | 12^{th} | 13^{th} | 14^{th} |
|---|---|---|---|---|---|
| No. | Treatment | of seed | day | day | day |
| 1 | Trail Blaze | 2.5 mL | 4 | 4 | 19 |
| | (TB) | | | | |
| 2 | TB + EN | 2.5 mL + | 4 | 4 | 16 |
| | | 1.0 mL | | | |
| 3 | TB + EN | 2.5 mL + | 4 | 7 | 16 |
| | | 2.0 mL | | | |
| 4 | TB + EN | 2.5 mL + | 4 | 5 | 16 |
| | | 5.0 mL | | | |
| 5 | TB + Neem | 2.5 mL + | 5 | 5 | 20 |
| | powder | 50 g | | | |
| 6 | Control | | 7 | 7 | 22 |

The data reflects that Trial Blaze (TB) (seed coating nutrient solution) in combination of EN controlling fall army worm on maize seedlings up to 14th days when the seedlings are more vulnerable to pest attack. It shows the seedlings become more resistant to pest attack.

We claim:

1. Bio pesticidal composition comprising nonanoate esters of sugars and sugar alcohols derived from C3 to C8 carbon atoms along with agriculturally acceptable ingredients, wherein the composition of esters are formed from mono, di, tri, tert- or higher order based on the number of available hydroxyl groups in the sugar, sugar alcohol moieties; wherein the nonanoate esters of sugar or sugar alcohol is present in a concentration ranging from 0.1% to 4% by weight of the composition; agriculturally acceptable ingredients are present in a concentration ranging from 0.1% to 96% by weight of the composition; and water in a concentration ranging from 0 to 90%.

2. The bio-pesticidal composition as claimed in claim 1, wherein the Nonanoate esters of sugars and sugar alcohols are selected from the group consisting of Erythritol Nonanoates, Xylitol Nonanoates, Sorbitol Nonanoates, Mannitol Nonanoates, Sucrose Nonanoates, Fructose Nonanoates, Glucose Nonanoates, Psicose Nonanoates, Xylose Nonanoates, Lactose Nonanoates, Galactose Nonanoates and Mannose Nonanoates.

3. The bio-pesticidal composition as claimed in claim 1, wherein the Nonanoate esters of sugar or sugar alcohol is Erythritol esters.

4. The bio-pesticidal composition as claimed in claim 1, wherein the Nonanoates esters of Erythritol is selected from the group consisting of Mono ester of erythritol nonanoate, Di ester of erythritol nonanoate, Tri ester of erythritol nonanoate and Tetra ester of erythritol nonanoate or combinations thereof.

5. The bio-pesticidal composition as claimed in claim 1, wherein the compositions optionally combined with seed treatment nutrient solutions to offer better germination and protection of the saplings against various pests at their early stages of growth.

6. The bio-pesticidal composition as claimed in claim 1, wherein the agriculturally acceptable ingredients are selected from the group consisting of
i) Oxidation pathway inhibitors such as gallic acid or tannic acid for reducing resistance,
ii) Other insecticides/pesticides natural or synthetic, plant nutrients, stimulants, hormones, PGR etc.,
iii) Pheromones,
iv) Surfactants, spreaders, stickers, penetrants etc.,
v) Carrier oil,
vi) anti-oxidants such as ethoxyquin, a tocopherol, BHT etc.,
vii) Arginine, Lysine, Glycine, nitrosglutathione, sodium nitrospruside, sodium hydrogen sulphide which may act as adjuvents,
viii) Nonionic, Cationic and Anionic surfacts such as Tween (Poly sorbate), or any secondary alcohol ethoxylate, Tergitol (anionic sulfonate), spreading agents such as Silwet (Polyalkyleneoxide modified heptamethyltrisiloxane) and long chain alcohol ranging from C 8 to C 20.

7. The bio-pesticidal composition as claimed in claim 1, wherein the composition comprising nonanoate esters of sugar/sugar alcohols formulated as an insecticidal soap along with agriculturally acceptable excipients selected from the group consisting of surfactants, carrier oil, anti-oxidants such as ethoxyquin, a tocopherol, BHT etc.

8. The bio-pesticidal composition as claimed in claim 1, wherein the compositions can be formulated into liquids, soaps, pellets, granules, suspensions, gels, solutions and aerosol sprays.

9. A process for the preparation of nonanoate esters of sugar and sugar alcohols are prepared by a process comprising the steps of,
a) reacting sugar/sugar alcohol with nonanoic acid or its acid chloride in a ratio of 1:0.9 to 1:7 in presence of a suitable solvent and reagents selected from the group consisting of acid catalyst, base catalyst, metal salt, Mitsunobu coupling, carbodimide coupling, carbonyl diimidazole (CDI), Lipase, Lews acid; and
b) recovering the nonanoate esters of sugars or sugar alcohol.

10. The process as claimed in claim 9, wherein the suitable solvents may be selected from the group consisting of polar aprotic solvents selected from DMF, DMSO and acetonitrile

11. The process as claimed in claim 9, wherein the Nonanoates esters of sugar and sugar alcohols are prepared by a process comprising the steps of;
(i) Adding Sugar/sugar alcohol to nonanoic acid in a ratio of 1:0.9 to 1:7 and heating the resultant mixture at a temperature ranging from 130° C. to 180° C.,
(ii) Adding 10 to 30% moles of Phosphoric acid with respect to sugar/sugar alcohol into the mixture of step (i), followed by heating for 8 to 48 h,
(iii) Cooling the mixture of step (ii) to 60-70° C., followed by diluting with ethyl acetate,
(iv) Treating the mixture of step (iii) with Ca(OH)₂ for 10 min at this temperature and
(v) Filtering the hot solution through celite bed followed by concentrating the filtrate under vacuum to obtain nonanoate esters of sugars or sugar alcohol.

12. The process as claimed in claim 9, wherein the Nonanoate esters of sugar and sugar alcohols are prepared by a process comprising of reaction of sugar/sugar alcohol and nonanoic acid in presence of carbonyl diimidazole (CDI) in DMF at 0-5° C.
